(19) United States
(12) Patent Application Publication
(10) Pub. No.: US 2022/0345765 A1
(43) Pub. Date: Oct. 27, 2022

(54) SCHEDULING DEVICE, SCHEDULING METHOD, AND PROGRAM

(71) Applicant: NEC Corporation, Minato-ku, Tokyo (JP)

(72) Inventors: Yasuhisa SUZUKI, Tokyo (JP); Werner WEE, Tokyo (JP); Itaru NISHIOKA, Tokyo (JP)

(73) Assignee: NEC Corporation, Minato-ku, Tokyo (JP)

(21) Appl. No.: 17/617,050

(22) PCT Filed: Jun. 11, 2019
(86) PCT No.: PCT/JP2019/023021

§ 371 Date: Dec. 7, 2021

(51) Int. Cl. H04N 21/262; H04N 21/458

(52) U.S. Cl. CPC H04N 21/26241; H04N 21/458

(57) ABSTRACT

A scheduling request related to a target advertisement that is to be scheduled are received. It is determined, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.

### TECHNICAL FIELD

The present invention relates to a scheduling device, a scheduling method, and a program.

### BACKGROUND ART

The work of scheduling to determine whether to broadcast a target advertisement in an advertisement broadcast time set in the broadcast time of any program among a plurality of programs to be broadcast on television or the like entails considerable labor.

Patent Document 1 discloses related technology. For example, Patent Document 1 discloses the technique of a spot automatic plan making system that automatically plans the scheduling of commercial spot broadcasts.

### PRIOR ART DOCUMENTS

### Non-Patent Documents

[Patent Document 1] Japanese Unexamined Patent Application, First Publication No. 2000-124867

### SUMMARY OF THE INVENTION

### Problem to be Solved by the Invention

What is desired is a technique that can reduce labor in the work of scheduling to determine whether to broadcast a target advertisement in an advertisement broadcast time set in the broadcast time of any program of a plurality of programs to be broadcast on television or the like as mentioned above.

### Means for Solving the Problem

A scheduling device according to one example embodiment of the present invention includes: a receiving unit that receives a scheduling request related to a target advertisement that is to be scheduled; and a scheduling unit that determines, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.

A scheduling method according to one example embodiment of the present invention includes: receiving a scheduling request related to a target advertisement that is to be scheduled; and determining, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.

A program according to one example embodiment of the present invention causes a computer of a scheduling device to function as: a receiving means for receiving a scheduling request related to a target advertisement that is to be scheduled; and a scheduling means for determining, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.

### Effect of the Invention

According to the present invention, in the work of scheduling to determine whether to broadcast a target advertisement in an advertisement broadcast time set in the broadcast time of any program of a plurality of programs to be broadcast on television or the like, it is possible to reduce the labor of the work.

### BRIEF DESCRIPTION OF THE DRAWINGS

FIG. 1 is a diagram showing an outline of a scheduling system according to the present example embodiment.

FIG. 2 is a diagram showing the hardware configuration of a scheduling device according to the present example embodiment.

FIG. 3 is a function block diagram of the scheduling device according to the present example embodiment.

FIG. 4 is a diagram showing an example of the web page of a scheduling request form according to the present example embodiment.

FIG. 5 is a first diagram showing the flow of processing of the scheduling device according to the present example embodiment.

FIG. 6 is a diagram showing a processing image of the management unit according to the present example embodiment.

FIG. 7 is a second diagram showing the flow of processing of the scheduling device according to the present example embodiment.

FIG. 8 is a third diagram showing the flow of processing of the scheduling device according to the present example embodiment.

FIG. 9 is a fourth diagram showing the flow of processing of the scheduling device according to the present example embodiment.

FIG. 10 is a fifth diagram showing the flow of processing of the scheduling device according to the present example embodiment.

FIG. 11 is a diagram showing a minimum configuration of the scheduling device according to the present example embodiment.

FIG. 12 is a diagram showing the flow of processing of the scheduling device having a minimum configuration according to the present example embodiment.

### EXAMPLE EMBODIMENT

Hereinbelow, a scheduling device according to an example embodiment of the present invention will be described with reference to the drawings.

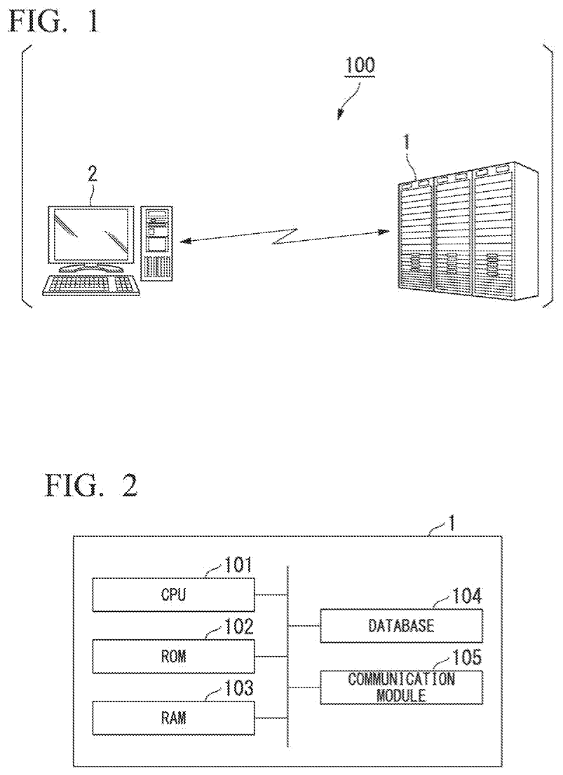

FIG. 1 is a diagram showing an outline of a scheduling system including a scheduling device according to the present example embodiment.

As shown in this figure, a scheduling system 100 is configured by communicatively connecting a scheduling device 1 and a terminal 2. The terminal 2 outputs information input from an operator to the scheduling device 1. The operator is, for example, an employee of a broadcasting company or an employee of an advertising agency. The operator may also be the person in charge at the advertiser. On the basis of the input information indicating an instruction of the operator, the scheduling device 1 performs a scheduling process that determines whether to broadcast a target advertisement in an advertisement broadcast time set in the broadcast time of any program of a plurality of programs to be broadcast on television or radio.

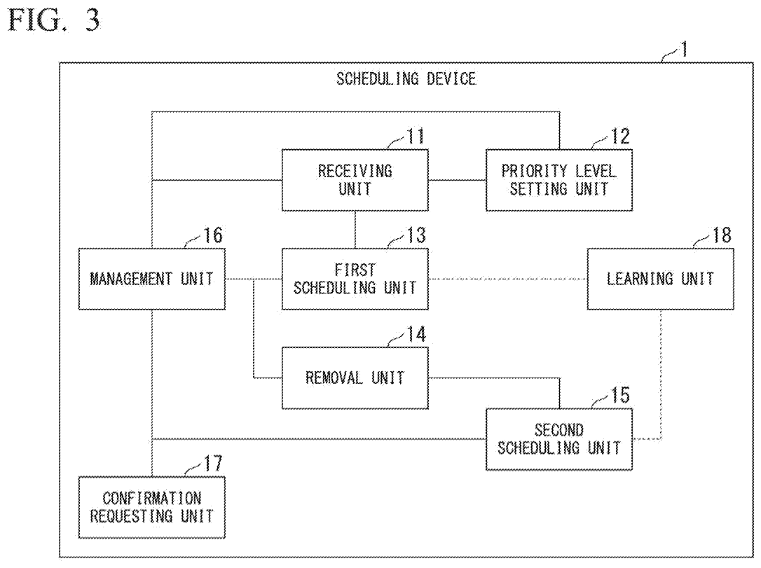

FIG. 2 is a diagram showing a hardware configuration of the scheduling device 1.

As shown in this figure, the scheduling device 1 is a computer including hardware such as a CPU (Central Processing Unit) 101, a ROM (Read Only Memory) 102, a RAM (Random Access Memory) 103, a database 104, and a communication module 105. The terminal 2 is also a computer having similar hardware.

FIG. 3 is a function block diagram of the scheduling device.

The CPU 101 of the scheduling device 1 is activated when the power supply is turned on, and executes a scheduling program stored in advance. As a result, the scheduling device 1 exhibits the functions of a receiving unit 11, a priority level setting unit 12, a first scheduling unit 13, a removal unit 14, a second scheduling unit 15, a management unit 16, a confirmation requesting unit 17, and a learning unit 18.

The receiving unit 11 receives a scheduling request regarding the target advertisement that is to be scheduled.

The priority level setting unit 12 sets or calculates the priority level of the target advertisement on the basis of information indicating a priority level index included in the scheduling request.

Among program scheduling data including respective attribute information regarding a plurality of programs in which advertisements are to be broadcast in advertisement broadcast times that are set in the program broadcast times, the first scheduling unit 13 acquires first program scheduling data in which the broadcast times of other advertisements are not set to any advertisement broadcast times. On the basis of the first program scheduling data and the scheduling request, the first scheduling unit 13 determines whether to broadcast a target advertisement in an advertisement broadcast time set in the broadcast time of any program, without considering the schedules of other advertisements.

As a result of the first scheduling process being performed on each of the target advertisement and the other target advertisements that have received a scheduling request in the past, the removal unit 14 determines whether one advertisement broadcast time is shorter than the total number of advertisement seconds of a plurality of target advertisements determined to be broadcast during the one advertisement broadcast time. When the one advertisement broadcast time is shorter than the total number of advertisement seconds of the plurality of target advertisements determined to be broadcast in the one advertisement broadcast time, the removal unit 14 removes on the basis of the priority level any of the plurality of target advertisements determined to be broadcast during the advertisement broadcast time.

The second scheduling unit 15 acquires, of the program scheduling data, second program scheduling data in which remaining target advertisements excluding the target advertisement removed for the advertisement broadcast time are set to be broadcast during the advertisement broadcast time. Then, the second scheduling unit 15 determines, on the basis of the second program scheduling data and the scheduling request relating to the removed target advertisement, whether to broadcast the removed target advertisement in an advertisement broadcast time set in the broadcast time of any program included in the second program scheduling data.

The management unit 16 acquires the information received by the receiving unit 11, the processing results of the first scheduling unit 13 and the removal unit 14, and the processing result of the second scheduling unit 15. On the basis of the acquired information, the management unit 16 performs control for determining the advertisement broadcast time to which the target advertisement is allocated on the basis of the scheduling request.

The confirmation requesting unit 17 outputs the schedule result of the target advertisement to an output device such as the terminal 2 used by the operator.

The learning unit 18 calculates the schedule algorithm performed by the first scheduling unit 13 and the second scheduling unit 15.

The scheduling device 1 provided with such function units determines, on the basis of: program scheduling data including respective attribute information regarding a plurality of programs in which advertisements are broadcast in advertisement broadcast times that are set in the program broadcast times; and the scheduling request, whether to broadcast the target advertisement in the advertisement broadcast time set in the broadcast time of any program among the plurality of programs. At this time, the scheduling device 1 determines whether to broadcast the target advertisement during the advertisement broadcast time set in the broadcast time of any program of the plurality of programs using information indicating a priority level index. The scheduling device 1 may determine whether to broadcast the target advertisement during the advertisement broadcast time set in the broadcast time of any program of the plurality of programs for each of a plurality of pieces of information indicating different priority level indices, and output each processing result determined on the basis of the plurality of pieces of information indicating different priority level indices. Then, the scheduling device 1 may accept the selection of any one of the processing results and schedule the target advertisement.

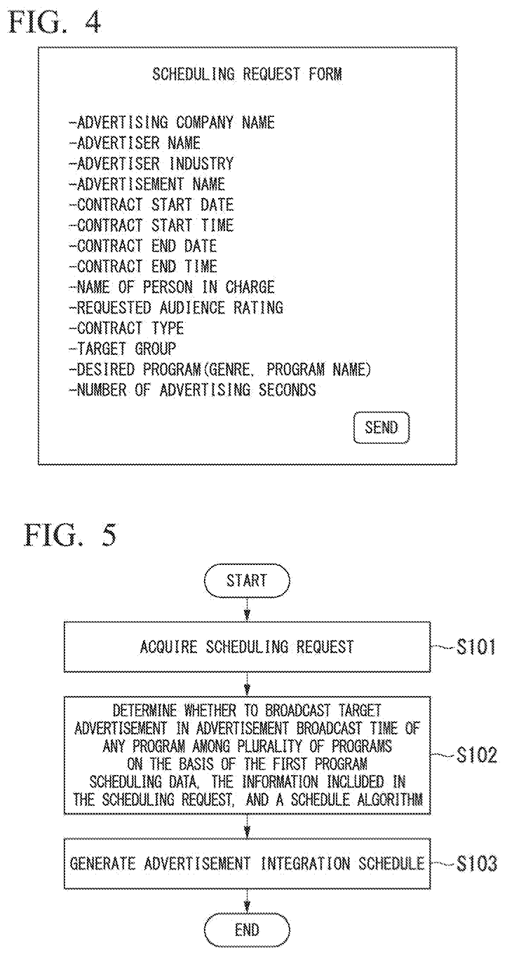

FIG. 4 is a diagram showing an example of a web page of the scheduling request form.

The receiving unit 11 of the scheduling device 1 exhibits a web server function. Thereby, the receiving unit 11 of the scheduling device 1 transmits a web page to the terminal 2 on the basis of the communication connection from the terminal 2. The web page is a scheduling request form or the like as shown in FIG. 4. The operator using the terminal 2 performs an operation of connecting the terminal 2 to the scheduling device 1. The terminal 2 and the scheduling device 1 are communicatively connected by HTTPS (Hyper Text Transfer Protocol Secure) communication or the like using the TCP (Transmission Control Protocol)/IP (Internet Protocol) function. At this time, the receiving unit 11 transmits the web page of the scheduling request form to the terminal 2. The terminal 2 displays the scheduling request form on a monitor. The web page of the scheduling request form contains input fields for various pieces of information. Each piece of information is a field for inputting information included in the scheduling request that is transmitted by the terminal to the scheduling device 1 by the operator pressing a send button on the web page of the scheduling request form. As an example, the web page of the scheduling request form includes input fields for various pieces of information such as the advertising company name, advertiser name, advertiser industry, advertisement name, contract start date, contract start time, contract end date, contract end time, name of person in charge, requested audience rating, contract type, target demographic, desired program, number of advertising seconds, and the like.

The advertising company name is the name of a company such as an advertising agency that provides support such as serving as an agent in advertising work for the advertiser and service provision.

The advertiser name is the name of the company or the like that requested the advertisement.

The advertiser industry is the industry to which the advertiser belongs.

The contract start date, contract start time, contract end date, and contract end time indicate the start date and start time of broadcasting the target advertisement, and the end date and end time of ending the broadcast, respectively.

The name of the person in charge may be the name of the person in charge at the advertiser or the advertising company, or the name of the operator.

The required audience rating is, for example, the audience rating for a television number when the target advertisement is broadcast at the advertisement broadcast time set in the broadcast time of the television number.

The contract form is information relating to the contract between the advertiser and the broadcasting company, such as the desired day of the week, the desired time frame, and the contract amount for broadcasting the target advertisement.

The target demographic is information indicating the expected age group, gender, etc. to which the products and services advertised in the target advertisement are provided.

The desired program is the name of the broadcast program that includes in the broadcast time thereof an advertisement broadcast time in which broadcast of the target advertisement is desired.

The number of advertising seconds is the time required to broadcast the target advertisement.

The web page of the scheduling request form may include input fields for other pieces of information.

FIG. 5 is the first diagram showing the flow of processing of the scheduling device.

Next, the flow of processing of the scheduling device 1 will be described.

First, the receiving unit 11 of the scheduling device 1 acquires a scheduling request based on an operation by the operator (Step S101). The receiving unit 11 outputs the scheduling request to the first scheduling unit 13 and the management unit 16. The management unit 16 records the information included in the scheduling request in the database 104 in association with the management ID. It is assumed that the management ID is a management number uniquely assigned to the scheduling request after the scheduling device 1 acquires the scheduling request.

The first scheduling unit 13 acquires the contract start date, contract start time, contract end date, and contract end time included in the scheduling request. The first scheduling unit 13 generates an advertisement broadcast start date corresponding to the contract start date, an advertisement broadcast start time corresponding to the contract start time, an advertisement broadcast end date corresponding to the contract end date, and an advertisement broadcast end time corresponding to the contract end time. The first scheduling unit 13 outputs to the management unit 16 an output request for program scheduling data specified in the broadcast period from the advertisement broadcast start time on the advertisement broadcast start date to the advertisement broadcast end time on the advertisement broadcast end date. The output request includes information on the advertisement broadcast start date, the advertisement broadcast start time, the advertisement broadcast end date, and the advertisement broadcast end time. The management unit 16 reads from the database 104 program scheduling data specified by the broadcast period from the advertisement broadcast start time of the advertisement start date to the advertisement broadcast end time of the advertisement broadcast end date, based on the information of the advertisement broadcast start date, the advertisement broadcast start time, the advertisement broadcast end date, and the advertisement broadcast end time. The program scheduling data is data in which the broadcast time of other advertisements is not set to any of the advertisement broadcast times, and this is referred to as first program scheduling data. The management unit 16 outputs the first program scheduling data to the first scheduling unit 13.

The first scheduling unit 13 determines whether to broadcast the target advertisement in the advertisement broadcast time set in the broadcast time of any program of a plurality of programs included in the first programming data, on the basis of the first program scheduling data, the information included in the scheduling request, and a schedule algorithm generated by the learning unit 18 (Step S102). The schedule algorithm may be a known schedule algorithm. As a result, the target advertisement is set to any of the advertisement broadcast times set in the broadcast time of any of the plurality of programs included in the first program scheduling data, in accordance with the advertiser's request indicated by the scheduling request. The scheduling process by the first scheduling unit 13 is called a first scheduling process. The first scheduling unit 13 outputs the processing result of the first scheduling process performed on the target advertisement to the management unit 16. The management unit 16 records the management ID and the processing result of the first scheduling process in the database 104 in association with each other.

The advertisement broadcast time set for one target advertisement based on the scheduling request is not necessarily one advertisement broadcast time set for the broadcast time of one program. The first scheduling unit 13 may set a plurality of advertisement broadcast times to be set for a certain target advertisement based on the information included in the scheduling request. For example, the first scheduling unit 13 may decide to broadcast the target advertisement in advertisement broadcast times included in all programs in the same time frame on weekday evenings in a certain period on the basis of the information included in the scheduling request. The first scheduling unit 13 may also decide to broadcast the target advertisement in advertisement broadcast times included in all the programs in a predetermined time frame on Saturday and Sunday morning in a certain period on the basis of the information included in the scheduling request. Further, the first scheduling unit 13 may decide to broadcast the target advertisement in all the advertisement broadcast times included in a predetermined plurality of desired programs in a certain period on the basis of the information included in the scheduling request.

The receiving unit 11, the management unit 16, and the first scheduling unit 13 repeat similar process each time a scheduling request is received from the terminal 2. As a result, the processing results of the first scheduling process corresponding to the plurality of scheduling requests are stored in the database 104. The program is assumed to be a program with a one-hour program broadcast time from 19:00:00 to 19:59:59 on a certain day, and in the program broadcast time of this program, a 3-minute first advertisement broadcast time from 19:15:00 to 19:17:59, a 3-minute second broadcast time from 19:30:00 to 19:32:59, and a 3-minute third broadcast time from 19:45:00 to 19:47:59 are assumed to be set, and it is assumed that the first scheduling unit 13 decides in the first scheduling process to broadcast the target advertisement during the second advertisement broadcast time. In such a case, the processing result of the first scheduling process includes, for example, the management ID, the program ID, the program broadcast time, identification information of the advertisement broadcast time in which the target advertisement is determined to be broadcast (information specifying the second advertisement broadcast time), and the day of the week and date of the broadcast of the program broadcast time in which the advertisement broadcast time is set.

The management unit 16 integrates the scheduling result of each target advertisement indicated by the processing result of the first scheduling process for each scheduling request recorded in the database 104, to thereby generating an advertisement integration schedule (Step S103). Each time the management unit 16 acquires the processing result of the first scheduling process, the management unit 16 may generate an advertisement integration schedule in which the processing result is integrated. The advertisement integration schedule includes, for example, information in which the identification information of the advertisement broadcast time set for each program in a certain period and the management ID of the target advertisement determined to be broadcast during that advertisement broadcast time are associated with each other.

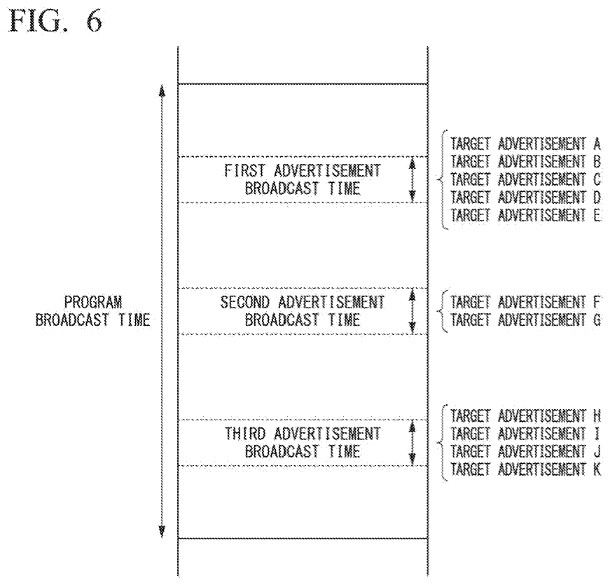

FIG. 6 is a diagram showing a processing image of the management unit.

As shown in FIG. 6, it is assumed that the management unit 16 sets three advertisement broadcast times, that is, the first advertisement broadcast time, the second advertisement broadcast time, and the third advertisement broadcast time in the program broadcast time of a certain program. The management unit 16 is assumed to have acquired a processing result of the first scheduling process for the target advertisements A, B, C, D, and E during the first advertisement broadcast time of the program. Further, it is assumed that the management unit 16 has acquired the processing result of the first scheduling process for the target advertisements F and G during the second advertisement broadcast time of the program. Further, it is assumed that the management unit 16 has acquired the processing result of the first scheduling process for the target advertisements H, I, J, K during the third advertisement broadcast time of the program. In this case, as shown in FIG. 6, the management unit 16 generates an advertisement integration schedule in which identification information of the target advertisements is assigned to the three advertisement broadcast times of the first advertisement broadcast time, the second advertisement broadcast time, and the third advertisement broadcast time set in the program broadcast time of a certain program according to the processing result of each first scheduling process. The advertisement integration schedule stores information on each target advertisement assigned by the processing result of the first scheduling process for each advertisement broadcast time of each program broadcast on each day of a certain period.

While the first scheduling unit 13 performs the first scheduling process, the priority level setting unit 12 specifies the priority level of the target advertisement indicated by the scheduling request. For example, the priority level setting unit 12 specifies the priority level based on the contract form included in the scheduling request. The priority level setting unit 12 may specify a priority value having a higher priority as the contract monetary amount indicated by the contract form increases. The priority level setting unit 12 may input the contract monetary amount indicated by the contract form into the priority calculation formula and calculate the priority level. The priority level setting unit 12 may specify a preset priority according to the frequency of scheduling requests of an advertiser in the past. The priority level setting unit 12 may specify a higher priority level as the order in which the advertiser's scheduling request is received is earlier. The priority level setting unit 12 may specify or calculate the priority level based on information included in the scheduling request or information associated with the advertiser or the advertising company stored in advance. The priority level setting unit 12 outputs the calculated priority level to the management unit 16. The management unit 16 records the management ID, assigned on the basis of the scheduling request, and the priority level in association with each other in the database 104.

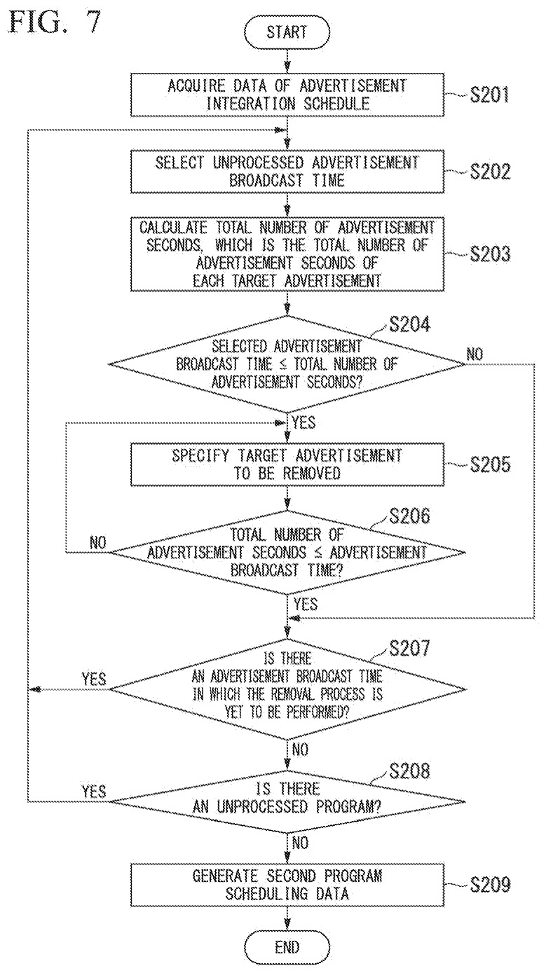

FIG. 7 is a second diagram showing the flow of processing of the scheduling device.

The management unit 16 outputs a removal processing request including the advertisement integration schedule generated for a certain period to the removal unit 14 at a predetermined timing. The predetermined timing may be the removal processing timing set at a certain time on the last day of the week indicated by the calendar, or may be the timing of newly acquiring the processing result of the first scheduling processing and updating the advertisement integration schedule on the basis of that processing result.

The removal unit 14 acquires the removal processing request. The removal unit 14 acquires the data of the advertisement integration schedule included in the removal processing request (Step S201). The removal unit 14 selects an unprocessed advertisement broadcast time from one or a plurality of advertisement broadcast times included in the unprocessed program among the programs included in the advertisement integration schedule (Step S202). The removal unit 14 reads each advertisement second of the target advertisement allocated to the specified advertisement broadcast time from the database 104. When the number of target advertisements allocated to the advertisement broadcast time is a plurality, the removal unit 14 calculates the total number of advertisement seconds, which is the total number of advertisement seconds of each target advertisement (Step S203). The removal unit 14 determines whether the selected advertisement broadcast time is equal to or less than the total number of advertisement seconds (Step S204). When the selected advertisement broadcast time is equal to or less than the total number of advertisement seconds, the removal unit 14 specifies the target advertisement to be removed from the plurality of target advertisements assigned to the advertisement broadcast time (Step S205). For example, the removal unit 14 acquires the priority level of each target advertisement from the database 104. This priority level is a priority level specified or calculated by the priority level setting unit 12. The removal unit 14 identifies the target advertisement having the lowest priority as the target advertisement to be removed based on the priority level of each target advertisement. If the selected advertisement broadcast time is longer than the total number of advertisement seconds, the removal unit 14 shifts to the process of Step S207.

The removal unit 14 determines whether the total number of advertisement seconds, which is the total number of advertising seconds for each of the remaining plurality of target advertisements after removing the target advertisement to be removed from the target advertisements allocated in the selected advertisement broadcast time, is equal to or less than the advertisement broadcast time (Step S206). If the total number of advertisement seconds is not less than or equal to the advertisement broadcast time, the removal unit 14 again specifies a target advertisement to be removed on the basis of the priority level. The removal unit 14 repeats the process of specifying the target advertisement to be removed until the total number of advertisement seconds becomes equal to or less than the advertisement broadcast time. The removal unit 14 outputs a deletion request including a management ID that specifies the target advertisement to be removed to the management unit 16. Further, the removal unit 14 outputs a second scheduling request including a management ID that specifies the target advertisement to be removed.

The removal unit 14 determines whether, among the advertisement broadcast times included in the selected program, there is an advertisement broadcast time in which the removal process of an assigned target advertisement is yet to be performed (Step S207). When there is an unprocessed advertisement broadcast time, the removal unit 14 selects that advertisement broadcast time and repeats the removal process in a similar manner. The removal unit 14 determines whether or not there is an unprocessed program including an advertisement broadcast time on which the removal process has not been performed among the programs included in the advertisement integration schedule (Step S208). If there is an unprocessed program, the removal unit 14 selects an unprocessed advertisement broadcast time from one or a plurality of advertisement broadcast times included in the program, and repeats similar removal process. When the removal unit 14 completes the removal process for all the programs included in the advertisement integration schedule, the removal unit 14 stands by for input from the management unit 16 with regard to the next other advertisement integration schedule.

The management unit 16 acquires a deletion request. The management unit 16 generates the second program scheduling data in which a target advertisement to be removed is deleted from the advertisement integration schedule (Step S209). The management unit 16 may generate the second program scheduling data in which, as a result of performing the deletion process in the second program scheduling data, a removal process completion flag is issued to the advertisement broadcast time in which the total number of seconds of each target advertisement included in the advertisement broadcast time is less than or equal to the advertisement broadcast time. Thereby, the management unit 16 may perform control such that the advertisement broadcast time so that a new target advertisement is not assigned to the advertisement broadcast time to which the removal process completion flag has been issued.

In the second program scheduling data, when the target advertisement assigned to an advertisement broadcast time has been finalized on the basis of other processing or an operation instruction by the administrator, the management unit 16 may generate second program scheduling data in which a finalization flag is issued. The management unit 16 may perform control so that a new target advertisement is not assigned to the advertisement broadcast time to which the finalization flag is issued.

It should be noted that even for an advertisement broadcast time in which the removal process completion flag or finalization flag has been issued, the scheduling device 1 may under a predetermined condition remove a target advertisement already assigned to the advertisement broadcast time and perform the process of assigning a new target advertisement to that advertisement broadcast time. For example, in the case of a target advertisement of an advertiser with the highest priority, even for an advertisement broadcast time in which the removal process completion flag or finalization flag has been issued in the above manner, the assigning process may be performed on the advertisement broadcast time. When the total advertisement seconds of the target advertisements allocated to the advertisement broadcast time again exceeds the advertisement broadcast time as a result of adding the new target advertisement of a high-priority advertiser to the advertisement broadcast time to which the removal process completion flag or finalization flag is issued, the management unit 16 may perform control to remove the removal process completion flag or finalization flag so as to again perform the removal processing by the removal unit 14.

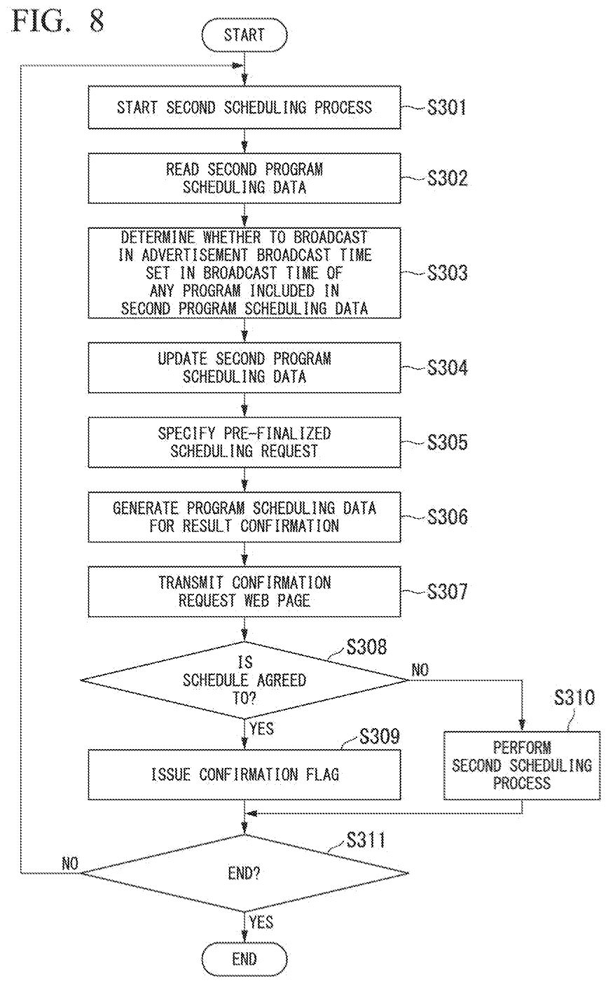

FIG. 8 is a third diagram showing the flow of processing of the scheduling device.

On the other hand, the second scheduling unit 15 acquires the second scheduling request from the removal unit 14. The second scheduling unit 15 acquires the management ID included in the second scheduling request. The second scheduling unit 15 starts the second scheduling process, which is the rescheduling process of the target advertisement that can be specified by the management ID (Step S301). The second scheduling unit 15 acquires the contract start date, contract start time, contract end date, and contract end time of the target advertisement based on the management ID. The second scheduling unit 15 generates an advertisement broadcast start date corresponding to the contract start date, an advertisement broadcast start time corresponding to the contract start time, an advertisement broadcast end date corresponding to the contract end date, and an advertisement broadcast end time corresponding to the contract end time. The second scheduling unit 15 outputs to the management unit 16 an output request of the second program scheduling data specified by the broadcast time from the advertisement broadcast start time of the advertisement broadcast start date to the advertisement broadcast end time of the advertisement broadcast end date. The output request of the second program scheduling data includes information on the advertisement broadcast start date, the advertisement broadcast start time, the advertisement broadcast end date, and the advertisement broadcast end time.

The management unit 16 reads from the database 104 the second program scheduling data specified by the broadcast time from the advertisement broadcast start time of the advertisement broadcast start date to the advertisement broadcast end time of the advertisement broadcast end date on the basis of the information of the advertisement broadcast start date, the advertisement broadcast start time, the advertisement broadcast end date, and the advertisement broadcast end time (Step S302). The second program scheduling data is the second program scheduling data in which the remaining target advertisements excluding the target advertisement removed for the advertisement broadcast time are set to be broadcast in the advertisement broadcast time. The management unit 16 outputs the second program scheduling data to the second scheduling unit 15.

The second scheduling unit 15 determines whether to broadcast the target advertisement specified by the management ID included in the second scheduling request at an advertisement broadcast time set in the broadcast time of any program of a plurality of programs included in the second program scheduling data, on the basis of the second program scheduling data, the information included in the second scheduling request, and the schedule algorithm generated by the learning unit 18 (Step S303). The schedule algorithm of the second scheduling unit 15 may be the same as the schedule algorithm of the first scheduling unit 13. As a result, the target advertisement is set to any of the advertisement broadcast times to which the removal process completion flag or finalization flag has not been issued, among the advertisement broadcast times set to the broadcast time of any program of the plurality of programs included in the second program scheduling data, in accordance with the advertiser's request indicated by the scheduling request. The scheduling process of the second scheduling unit 15 is called a second scheduling process. The second scheduling unit 15 outputs the processing result of the second scheduling processing performed on the target advertisement to the management unit 16. The management unit 16 records the management ID and the processing result of the second scheduling process in the database 104 in association with each other.

The second scheduling unit 15 repeats similar process each time a second scheduling request is acquired from the removal unit 14. Thereby, the second scheduling unit 15 can determine whether to broadcast the removed target advertisement in an advertisement broadcast time set in the broadcast time of any program included in the second program scheduling data, on the basis of the second program scheduling data and the second scheduling request relating to the removed target advertisement.

Then, the management unit 16 updates the second program scheduling data by adding thereto the scheduling result of each target advertisement indicated by the processing result of the second scheduling process recorded in the database 104 (Step S304). Adding the processing result of the second scheduling process to the second program scheduling data means, for example, storing in the second program scheduling data each piece of information of the management ID, the program ID, and the program broadcast time, day and date, in the case of the management ID, program ID, program broadcast time, identification information of the advertisement broadcast time in which the target advertisement is determined to be broadcast, and the day of the week and day and date at which the advertisement broadcast time has been set being included in the processing result of the second scheduling process. Each time the management unit 16 acquires the processing result of the second scheduling process, the management unit 16 may add the processing result to the second program scheduling data.

On the basis of a plurality of scheduling requests, it is determined whether to broadcast the target advertisement of the scheduling indicated by the plurality of scheduling requests in an advertisement broadcast time set in the broadcast time of any program among the programs by each process of the receiving unit 11, the priority level setting unit 12, the first scheduling unit 13, the removal unit 14, the second scheduling unit 15, and the management unit 16.

The confirmation requesting unit 17 requests the management unit 16 to output information of yet-to-be-finalized scheduling requests among the scheduling requests stored in the database 104. It is assumed that the management unit 16 performs management by issuing finalization flags indicating that the scheduling requests are not finalized or finalized and recording the confirmation flags in the database 104. The management unit 16 specifies the scheduling request recorded at the oldest time among the scheduling request information recorded in the database 104 in association with a finalization flag indicating not finalized (Step S305). The management unit 16 acquires the management ID included in that scheduling request. The management unit 16 acquires the acquired management ID and the second program scheduling data including the management ID from the database 104, and outputs them to the confirmation requesting unit 17.

On the basis of the acquired management ID and the second program scheduling data including the management ID, the confirmation requesting unit 17 deletes processing results associated with other management IDs different from the management ID acquired from the second program scheduling data, and generates program scheduling data for schedule result confirmation (Step S306). Since the processing results associated with other management IDs different from the management ID acquired from the second program scheduling data have been deleted, the program scheduling data for schedule result confirmation is program scheduling data in which only the target advertisement schedule corresponding to the acquired management ID and the schedule of the program are included. The confirmation requesting unit 17 instructs the receiving unit 11 to transmit a confirmation request web page including a management ID and program scheduling data for schedule result confirmation. The receiving unit 11 transmits the confirmation request web page to the terminal 2 (Step S307). The receiving unit 11 may transmit a confirmation request web page including the program scheduling data for schedule result confirmation to the terminal 2 on the occasion of the next communication connection from the terminal 2.

The terminal 2 receives the confirmation request web page. The terminal 2 displays the program scheduling data for schedule result confirmation included in the confirmation request web page. The terminal 2 may display a scheduling table that highlights the advertisement broadcast time frame of the target advertisement in the program table on the basis of the program scheduling data for schedule result confirmation, based on a display program stored in advance. The operator prints out the scheduling table or outputs the data thereof. Then, the operator confirms whether the advertising company or the advertiser agree with the scheduling in the advertisement broadcast time for the target advertisement shown in the scheduling table. The operator may be the person in charge of marketing at the advertiser. On the program scheduling data web page for confirming the schedule result displayed by the terminal 2, the operator can input information indicating agreement with the scheduling table, or in the case of non-agreement, information sent as a change request, and performs transmission of the information to the scheduling device 1. The terminal 2 accepts input of information indicating agreement with the scheduling table, or information transmitted as a schedule change request if there is no agreement. Then, the terminal 2, upon acquiring the transmission instruction for information received by the operator's operation, transmits a confirmation result including the information for which the input has been accepted and the management ID to the scheduling device 1.

The receiving unit 11 acquires the confirmation result information and outputs the confirmation result information to the confirmation requesting unit 17. When the confirmation result information indicates an agreement, the confirmation requesting unit 17 outputs the management ID and information indicating an agreement to the management unit 16. The management unit 16 determines whether or not the schedule of the target advertisement corresponding to the management ID has been agreed to (Step S308). Upon recognizing that the schedule of the target advertisement corresponding to the management ID has been agreed to, the management unit 16 issues a confirmation flag indicating confirmation, showing that the schedule of the management ID has been confirmed, to the second program scheduling data including the management ID (Step S309).

Upon recognizing that the schedule of the target advertisement corresponding to the management ID lacks agreement due to the inclusion of the schedule change request in the confirmation result, the confirmation requesting unit 17 outputs the management ID and the schedule change request to the management unit 16. Upon acquiring the schedule change request, the management unit 16 updates the information included in the schedule request specified on the basis of the management ID to the information included in the schedule change request. The management unit 16 outputs a second scheduling request including the updated schedule request and the management ID to the second scheduling unit 15. The second scheduling unit 15 performs the second scheduling process in a similar manner as described above (Step S310).

It is assumed that a confirmation flag indicating confirmation is issued to the management IDs of all the target advertisements set at a certain advertisement broadcast time. The management unit 16 may update the second program scheduling data by issuing a finalization flag to the advertisement broadcast time when the total number of advertisement seconds, which is the total number of advertisement seconds of the target advertisements indicated by those management IDs, matches the advertisement broadcast time or is less than the advertisement broadcast time, and the number of seconds remaining after subtracting the total number of advertisement seconds from the advertisement broadcast time is within the specified time.

The management unit 16 determines whether to end the process (Step S311). If the process is not completed, the process from Step S301 is repeated. Then, based on the confirmation request from the scheduling device 1 to the terminal 2 and the schedule change request from the terminal 2 to the scheduling device 1, the above-mentioned processing is repeated to allocate the target advertisement to the advertisement broadcast time.

By the above process, the management unit 16 repeats the process of issuing a finalization flag to the management IDs of all the target advertisements based on the schedule requests set in the second program scheduling data. Upon acquiring an output instruction of the program scheduling data for a certain period from the administrator of the broadcasting company or the like, the management unit 16 outputs the second program scheduling data for that period to a monitor or the like. In the second program scheduling data, there may be a target advertisement to which a confirmation flag has not yet been issued.

In the above example, it is assumed that the operator who operates the terminal 2 is a person in charge at the advertiser, a person in charge at an advertising company, a person in charge or administrator at a broadcasting company, or the like. When the operator is the person in charge at the advertiser, the terminal 2 is a computer installed at the firm of the advertiser or the like, and the terminal 2 communicates with the scheduling device 1 via the Internet, a dedicated communication line, or the like. When the operator is a person in charge at the advertising company, the terminal 2 is a computer installed in the firm of the advertising company, and the terminal 2 communicates with the scheduling device 1 via the Internet, a dedicated communication line, or the like. When the operator is a person in charge at the broadcasting company, the terminal 2 is a computer installed in the broadcasting company or the like, and the terminal 2 communicates with the scheduling device 1 via an in-house LAN, the Internet, a dedicated communication line, or the like.

According to the above-mentioned processing, the scheduling device 1 determines whether to broadcast a target advertisement indicated by a scheduling request in an advertisement broadcast time set in the broadcast time of any program of a plurality of programs, on the basis of a scheduling request from the terminal 2 and the program scheduling data. As a result, since it is automatically determined whether to broadcast the target advertisement in the advertisement broadcast time set in the broadcast time of any program of the plurality of programs, it is possible to reduce the labor of the operator and possible to achieve a shortening of working hours.

Further, according to the above-mentioned process, the scheduling device 1 allocates the target advertisement to the advertisement broadcast time by a schedule algorithm that allocates the target advertisement to the advertisement broadcast time according to a scheduling request acquired from the terminal 2. Accordingly, since the target advertisement can be allocated to the advertisement broadcast time without deviating from the information indicated by the scheduling request, it is possible to reduce the check work of the operator.

Further, according to the above-mentioned processing, the scheduling device 1 performs the removal process in accordance with the priority level of the target advertisement so that the total number of advertisement seconds of one or a plurality of target advertisements allocated to the advertisement broadcast time does not exceed the advertisement broadcast time. Therefore, the operator can reduce the work of checking for mistakes in which a target advertisement is assigned beyond the range of the advertisement broadcast time.

According to the above-mentioned processing, the scheduling device 1 transmits the scheduling request form to the terminal 2, and, on the basis of the scheduling request including the information input in the scheduling request form, allocates the target advertisement to the advertisement broadcast time. Therefore, by performing the allocation process to the advertisement broadcast time based on schedule requests for target advertisements by different forms according to the operator and a schedule algorithm, it is possible to allocate target advertisements to the advertisement broadcast time with constant quality in response to a schedule request instructed by any operator. Even an operator who does not have advanced scheduling skills can use the scheduling device 1 to allocate a target advertisement to the advertisement broadcast time.

Next, the processing of the learning unit 18 described above will be described. The learning unit 18 calculates the objective function and the constraint condition to be used in the generation of the schedule data of a target advertisement on the basis of the determined schedule data regarding the target advertisement of the schedule and the features of the target advertisement of the schedule. As an example, the above-mentioned first scheduling unit 13 and second scheduling unit 15 use the features of a yet-to-be-scheduled target advertisement, the objective function, and the constraint condition to perform scheduling of the yet-to-be-scheduled target advertisement.

The learning unit 18 may calculate an objective function for each target advertisement. The learning unit 18 may calculate the objective function and the constraint condition for each group determined on the basis of the features of the target advertisements. Further, the first scheduling unit 13 and the second scheduling unit 15 may specify a group on the basis of the features of a new target advertisement and perform scheduling of a yet-to-be-scheduled target advertisement using the objective function and the constraint condition calculated for the group.

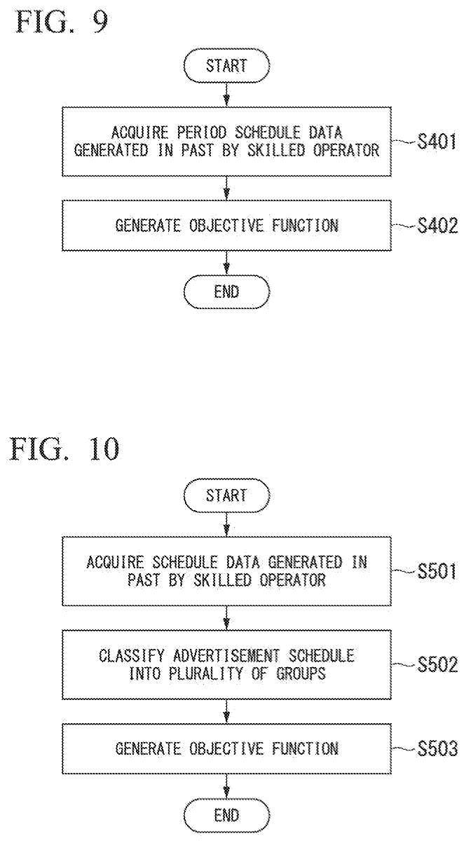

FIG. 9 is a fourth diagram showing the flow of processing of the scheduling device.

Next, the first learning process of the scheduling device 1 will be described.

The database 104 of the scheduling device 1 may store the schedule data of advertisements generated by operators such as skilled operators in the past according to the advertisements, or the types and attributes of the advertisements. The learning unit 18 acquires the instruction information for starting processing. The processing start instruction information may be acquired by the scheduling device 1 based on, for example, an instruction of the administrator who manages the scheduling device 1. The advertisement schedule data may be data obtained by extracting only the advertisement schedule from the program scheduling data.

The learning unit 18 acquires period schedule data Xe={x1, x2, x3, . . . xM} generated in the past by an operator such as a skilled operator from the database 104 based on the acquisition of the instruction information (Step S401). The period schedule data Xe includes at least an advertisement schedule x for each target advertisement (x1, x2, x3, . . . xM). The learning unit 18 may sequentially acquire the advertisement schedule x for each target advertisement included in the period schedule data Xe generated in the past by the skilled operator one by one. The period schedule data Xe={x1, x2, x3, . . . xM} generated in the past by an operator such as a skilled operator includes a schedule of each target advertisement allocated in a predetermined broadcast contract period. The advertisement schedule x includes information on the individual schedule of the target advertisement and feature information of the target advertisement. The period schedule data Xe may include program information including the date and time and features of the program in addition to the information of the advertisement schedule x.

Here, it is assumed that the period schedule data Xe generated in the past by an operator such as skilled operator is the result of the following mathematical optimization.

$$[ Equation 1 ]$$

$${max}_{x} {θ}^{T} Φ ( x ) , s . t . x ∈ X \qquad ( 1 )$$

In Equation (1), 0 is a unique parameter according to the operator such as a skilled operator, being a unique parameter that determines the scheduling method of the operator such as a skilled operator. In Equation (1), only the value of 0 is unknown. φ represents the feature information and the constraint condition of the advertisement schedule x. The feature information includes, for example, information such as the age group and gender targeted by the target advertisement, day of the week of broadcast, the content type of the advertisement, and the type of the program broadcast before and after the broadcast time of the target advertisement. The constraint condition includes for example information such as the time frame in which broadcast must occur, the type of program to be broadcast before or after the target advertisement, and the like. Equation (1) means that an operator such as a skilled operator creates the schedule x of the target advertisement in which the value of θTφ(x) is maximized.

The learning unit 18 uses the period schedule data Xe={x1, x2, x3, . . . xM} generated in the past by an operator such as a skilled operator to estimate by reverse-optimization the unique parameter θ of the operator such as a skilled operator. More specifically, the learning unit 18 performs inverse optimization based on the maximum likelihood method.

$$[ Equation 2 ]$$

$${θ}^{*} = {arg max}_{θ} p ( {X}_{e} \vert θ ) \qquad ( 2 )$$

In a situation where the period schedule data Xe generated in the past by an operator such as a skilled operator is given, let a parameter θ* that maximizes the likelihood p(Xe|θ) be the parameter of the operator such as the skilled operator. For the likelihood p(Xe|θ), for example, the following Equation (3) is used.

$$\begin{matrix}[ Equation 3 ] & \\ p ( {x}_{i} \vert θ ) = \frac{exp {θ}^{T} Φ ( {x}_{i} )}{{\sum }_{{x}_{i} ∈ X} exp {θ}^{T} Φ ( {x}_{i} )} & ( 3 )\end{matrix}$$

Taking the logarithm assuming that the period schedule data Xe={x1, x2, x3, . . . xM} generated in the past by an operator such as a skilled operator is generated from an independent identical distribution, Equation (2) becomes the following Equation (4).

$$\begin{matrix}[ Equation 4 ] & \\ {θ}^{*} = ar {g m}_{θ} ax ( {\sum }_{i = 1}^{M} log p ( {x}_{i} \vert θ ) ) & ( 4 )\end{matrix}$$

The learning unit 18 uses the steepest ascend method to calculate Anew, which updates parameter θ*.

$$\begin{matrix}[ Equation 5 ] & \\ {θ}^{new} = {θ}^{old} + α \frac{θ}{\partial θ} log p ( {x}_{i} \vert θ ) & ( 5 )\end{matrix}$$

The learning unit 18 can determine an arbitrary value for α by the step size. Further, when the learning unit 18 adopts Equation (3) as the equation expressing the likelihood p, the parameter is updated as shown in the following Equation (6).

[Equation 6]

θ^{new}=θ^{old}+α(Φ(xᵢ)−Φ(x)) (6)

In the above Equation (6), φ(xi) is a feature amount extracted from the advertisement schedule x of the target advertisement to be processed in the period schedule data Xe generated in the past by an operator such as a skilled operator. Further, φ(xi) is a feature amount of the advertisement schedule x generated under the parameter θold. The learning unit 18 may sequentially and separately acquire the advertisement schedule x for each target advertisement included in the period schedule data Xe generated in the past by the skilled operator, and in this case, the learning unit 18 sequentially updates the unique parameter of the operator such as a skilled operator by the above process at each such acquisition. Then, the learning unit 18 generates an objective function including the parameter Anew for the entire target advertisement included in the period schedule data Xe generated in the past by an operator such as a skilled operator (Step S402).

Then, on the basis of the scheduling request and the learning result by the learning unit 18, the first scheduling unit 13 performs the first scheduling process, and the second scheduling unit 15 performs the second scheduling process. Specifically, the scheduling request includes feature information and constraint conditions related to the target advertisement. The feature information may include, as described above, information such as the age group and gender targeted by the advertisement entered in the scheduling request form, the day of the week of broadcast, the content type of the advertisement, and the type of the program broadcast before and after the broadcast time of the target advertisement. The constraint condition may include the time frame in which broadcast must occur, the type of program to be broadcast before or after the target advertisement is performed, and the like. The constraint condition may be stored in advance by the scheduling device 1 and this constraint condition may be used.

Then, for example, the second scheduling unit 15 acquires the feature information and the constraint conditions of the target advertisement indicated by the scheduling request on the basis of the scheduling request. The second scheduling unit 15 acquires the objective function generated by the learning unit 18. The second scheduling unit 15 inputs, in the objective function (Equation 7), feature information and constraint conditions, program scheduling data that includes the period for scheduling the target advertisement and target advertisements already set in that period (not necessary if not set), and information included in the scheduling request including such as the date and time of the target advertisement. As a result, the second scheduling unit 15 calculates the schedule in the optimum program scheduling data of the target advertisement based on the scheduling request (specifies the advertisement broadcast time). The schedule includes at least information on the date and time of the target advertisement.

$$[ Equation 7 ]$$

$${max}_{( schedule )} J ( schedule , θ ) \qquad ( 7 )$$

Through the above processing, the scheduling device 1 calculates the objective function used to generate the schedule data of the target advertisement on the basis of the determined schedule data regarding the target advertisement of the schedule and the features of the target advertisement. At this time, based on the determined schedule data generated in the past, the scheduling device 1 uses a method of inverse optimization to calculate an objective function containing parameters specific to the scheduling method of an operator (skilled operator or the like) who generated the determined schedule data. Then, using the features of the yet-to-be-scheduled target advertisement and the objective function, the scheduling device 1 generates schedule data of the yet-to-be-scheduled target advertisement.

Through such processing, the scheduling device 1 can provide a scheduling device that automatically generates schedule data (program scheduling data) of a target advertisement in a similar manner to the operator (skilled operator or the like) who generated the determined schedule data.

FIG. 10 is a fifth diagram showing the flow of processing of the scheduling device.

Next, the second learning process of the scheduling device 1 will be described.

The database 104 of the scheduling device 1 stores schedule data generated by an operator such as a skilled operator in the past. The learning unit 18 acquires instruction information for starting processing.

The learning unit 18 acquires the period schedule data Xe={x1, x2, x3, . . . xM} generated in the past by an operator such as a skilled operator from the database 104 based on the acquisition of the instruction information (Step S501). The period schedule data Xe includes at least an advertisement schedule x (x1, x2, x3, . . . xM) for each target advertisement. The learning unit 18 may sequentially acquire the advertisement schedule x for each target advertisement included in the period schedule data Xe generated in the past by the skilled operator one by one. The period schedule data Xe={x1, x2, x3, . . . xM} generated in the past by an operator such as a skilled operator includes a schedule of each target advertisement allocated in a predetermined broadcast contract period. The advertisement schedule x includes feature information on the individual schedule of the target advertisement and feature information of the target advertisements. The period schedule data Xe may include program information including the date and time and features of the program in addition to the information of the advertisement schedule x.

The learning unit 18 classifies each advertisement schedule x included in the acquired period schedule data Xe into a plurality of groups (Step S502). For example, the learning unit 18 performs clustering and classification using the k-means clustering method or the like based on the feature information of each advertisement schedule x. The learning unit 18 may perform classification into a plurality of groups based on past schedule data created by an operator such as a skilled operator. In this case, the learning unit 18 extracts a feature amount from the schedule data and classifies each advertisement schedule x into a plurality of groups based on the feature amount. The feature amount may be an audience rating acquired on each day of the week, an audience rating acquired in each time frame, or the like. When performing classification based on past schedule data, group allocation cannot be performed for new target advertisements since there is no past schedule. Therefore, the operator may be allowed to classify the advertisement schedule x into a plurality of groups.

When the process of classifying each advertisement schedule x into a plurality of groups is completed, the learning unit 18 uses the feature information of each advertisement schedule x included in the group to perform inverse optimization processing as in the first learning process. Then, the learning unit 18 generates an objective function including the parameter Anew for the group including each advertisement schedule x generated in the past by an operator such as a skilled operator in the same manner as in the first learning process (Step S503). The learning unit 18 determines whether or not the objective function has been calculated for all the groups (Step S504). The learning unit 18 repeats the process until objective functions for all the groups are calculated. The learning unit 18 may perform the objective function calculation process immediately after performing the process of classifying each advertisement schedule x into a plurality of groups, or may perform each process at different timings. When performing the objective function calculation process immediately after performing the process of classifying each advertisement schedule x into a plurality of groups, the learning unit 18 may perform those processes using the same feature information. When the process of classifying each advertisement schedule x into a plurality of groups and the objection function calculation process are performed at different timings, the learning unit 18 may perform those processes using different feature information.

Then, the scheduling device 1 receives the scheduling request from the terminal 2. The first scheduling unit 13 and the second scheduling unit 15 of the scheduling device 1 acquire the feature information and the constraint conditions of the target advertisement included in the received scheduling request. The first scheduling unit 13 and the second scheduling unit 15 specify the group on the basis of the feature information and the constraint conditions acquired from the scheduling request. For example, the first scheduling unit 13 and the second scheduling unit 15 specify a group including each advertisement schedule classified in the same manner on the basis of the feature information and the constraint condition that resemble feature information and the constraint condition acquired from the scheduling request.

Then, for example, the second scheduling unit 15 acquires the objective function calculated by the learning unit 18 for the specified group. The second scheduling unit 15 inputs, in the objective function (Equation 7), feature information and constraint conditions, program scheduling data that includes the period for scheduling the target advertisement and target advertisements already set in that period (not necessary if not set), and information included in the scheduling request including such as the date and time of the target advertisement. As a result, the second scheduling unit 15 calculates the schedule in the optimum program scheduling data of the target advertisement based on the scheduling request.

Through such processing, the scheduling device 1 can provide a scheduling device that automatically generates schedule data with high accuracy similar to an operator skilled in scheduling work, using an objective function specific to the group to which a yet-to-be-scheduled target advertisement belongs.

FIG. 11 is a diagram showing the minimum configuration of the scheduling device.

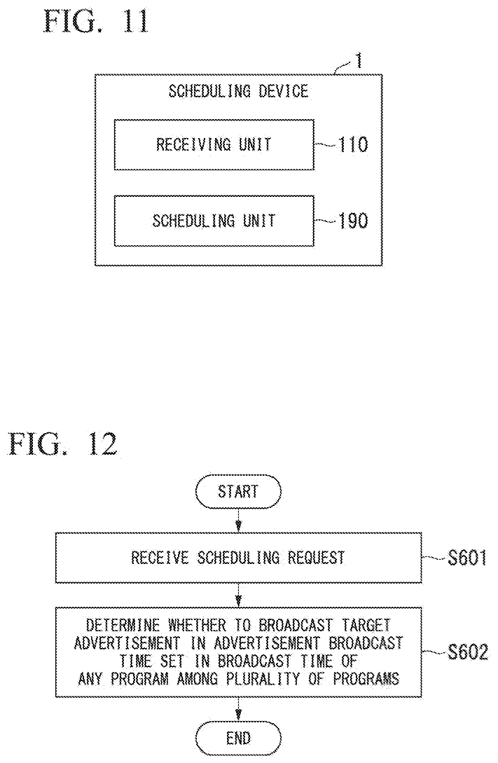

FIG. 12 is a diagram showing the flow of processing of the scheduling device with the minimum configuration.

As shown in FIG. 11, the scheduling device exhibits at least the functions of the receiving unit 110 and the scheduling unit 190.

The receiving unit 110 receives a scheduling request relating to the target advertisement to be scheduled (Step S601).

The scheduling unit 190 determines, on the basis of: program scheduling data including respective attribute information regarding a plurality of programs in which advertisements are broadcast in advertisement broadcast times that are set in the program broadcast times; and the scheduling request, whether to broadcast the target advertisement in the advertisement broadcast time set in the broadcast time of any program among the plurality of programs (Step S602).

The above-mentioned scheduling device 1 has a computer system inside. The process of each process described above is stored in a computer-readable recording medium in the form of a program, with the process being performed by the computer reading and executing this program. Here, the computer-readable recording medium refers to a magnetic disk, a magneto-optical disk, a CD-ROM, a DVD-ROM, a semiconductor memory, or the like. Further, this computer program may be distributed to a computer via a communication line, and the computer receiving the distribution may execute the program.

The above program may be for realizing some of the above-mentioned functions. Moreover, a so-called differential file (differential program) may be used, which can realize the above-mentioned functions in combination with a program already recorded in the computer system.

### REFERENCE SYMBOLS

1: Scheduling device
2: Terminal
11: Receiving unit
12: Priority level setting unit
13: First scheduling unit
14: Removal unit
15: Second scheduling unit
16: Management unit
17: Confirmation requesting unit
18: Learning unit
100: Scheduling system

What is claimed is:

1. A scheduling device comprising:
at least one memory configured to store instructions;
at least one processor configured to execute the instructions to:
receive a scheduling request related to a target advertisement that is to be scheduled; and
determine, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.

2. The scheduling device according to claim 1, wherein the at least one processor is configured to execute the instructions to determine whether to broadcast the target advertisement in an advertisement broadcast time set in the broadcast time of any program of the plurality of programs using information indicating an index of a priority level.

3. The scheduling device according to claim 2, wherein the at least one processor is configured to execute the instructions to determine whether to broadcast the target advertisement in an advertisement broadcast time set in the broadcast time of any program of the plurality of programs for each of a plurality of pieces of information each indicating an index of a different priority level, output each processing result determined based on the plurality of pieces of information each indicating the index of the different priority level, and receive selection of any one of the processing results.

4. The scheduling device according to claim 2,
wherein the scheduling request includes information indicating the index of the priority level, and the priority level is calculated based on the information indicating the index of the priority level, and
the at least one processor is configured to execute the instructions to determine whether to broadcast the target advertisement in an advertisement broadcast time set in the broadcast time of any program of the plurality of programs based on the priority level.

5. The scheduling device according to claim 1, wherein the at least one processor is configured to execute the instructions to:
perform a first scheduling process of determining whether to broadcast the target advertisement in the advertisement broadcast time set in the broadcast time of any program without considering schedules of any other advertisements, based on: first program scheduling data in which a broadcast time of other advertisements are not set to any advertisement broadcast times among the program scheduling data; and the scheduling request; and
remove, when one advertisement broadcast time is shorter than total number of advertisement seconds of a plurality of target advertisements determined to be broadcast during the one advertisement broadcast time as a result of the first scheduling process being performed on each of the target advertisement and another target advertisement for which a scheduling request was received in past, any of the plurality of target advertisements determined to be broadcast during the advertisement broadcast time, based on a priority level.

6. The scheduling device according to claim 5, wherein the at least one processor is configured to execute the instructions to:
perform a second scheduling process of determining, based on: second program scheduling data in which a remaining target advertisement excluding the target advertisement removed for the advertisement broadcast time is set to be broadcast during the advertisement broadcast time among the program scheduling data; and a scheduling request relating to the removed target advertisement, whether to broadcast the removed target advertisement in the advertisement broadcast time set in the broadcast time of any program included in the second program scheduling data.

7. A scheduling method comprising:
receiving a scheduling request related to a target advertisement that is to be scheduled; and
determining, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.

8. A non-transitory computer-readable recording medium storing a program that causes a computer of a scheduling device to execute:
receiving a scheduling request related to a target advertisement that is to be scheduled; and
determining, based on: program scheduling data including respective attribute information related to a plurality of programs in which an advertisement is to be broadcast in an advertisement broadcast time that is set in a program broadcast time; and the scheduling request, whether to broadcast the target advertisement in an advertisement broadcast time set in the broadcast time of any program of the plurality of programs.
